(19) United States
(12) Patent Application Publication
(10) Pub. No.: US 2019/0360845 A1
(43) Pub. Date: Nov. 28, 2019

(54) MULTI-ROTATIONAL ABSOLUTE ROTATION ANGLE DETECTING DEVICE AND GEAR

(71) Applicant: FANUC CORPORATION, Yamanashi (JP)

(72) Inventors: Nobuyuki Ootake, Yamanashi-ken (JP); Masao Fukuda, Yamanashi-ken (JP)

(73) Assignee: FANUC CORPORATION, Yamanashi (JP)

(21) Appl. No.: 16/419,418

(22) Filed: May 22, 2019

(30) Foreign Application Priority Data
May 23, 2018 (JP) 2018-098625

(51) Int. Cl. G01D 5/347

(52) U.S. Cl. CPC G01D 5/3473; G01D 5/34776

(57) ABSTRACT

In an encoder device, a first gear is made of a transparent resin allowing transmission of light and includes: a detection target on which an optical pattern for detecting the absolute rotation angle within one rotation is formed, and a plurality of teeth formed on the outer periphery of the detection target. A first sensor includes a light emitter configured to emit light toward the detection target and a light receiver configured to receive the light transmitted through the detection target.

### CROSS-REFERENCE TO RELATED APPLICATION

This application is based upon and claims the benefit of priority from Japanese Patent Application No. 2018-098625 filed on May 23, 2018, the contents of which are incorporated herein by reference.

### BACKGROUND OF THE INVENTION

### Field of the Invention

The present invention relates to a multi-rotational absolute rotation angle detecting device for detecting a rotation angle of a shaft as well as relating to a gear used for the multi-rotational absolute rotation angle detecting device.

### Description of the Related Art

Japanese Laid-Open Patent Publication No. 2003-065799 discloses an encoder device (rotation angle detecting device) which detects the rotation angle of a rotary shaft of a second gear by being meshed with a first gear (reduction gear) held on a common rotary shaft with a rotor having a plurality of slits formed on a concentric circle at equal intervals. In this encoder device, the rotor is attached to the first gear (the rotor and the first gear are arranged so as to be stacked together in the direction of the rotary shaft).

### SUMMARY OF THE INVENTION

The encoder device of Japanese Laid-Open Patent Publication No. 2003-065799 has room for improvement in thinning.

According to a first aspect of the present invention, a multi-rotational absolute rotation angle detecting device includes: a first shaft, a first gear provided on the first shaft and configured to rotate about the rotation axis of the first shaft; a second shaft; a second gear provided on the second shaft and configured to rotate about the rotation axis of the second shaft and mesh with the first gear; a first rotation angle detector configured to detect the rotation angle of the first shaft; and a second rotation angle detector configured to detect the rotation angle of the second shaft, and the first gear is made of a transparent resin allowing transmission of light, and includes a detection target on which an optical pattern for detecting the absolute rotation angle within one rotation is formed, and a plurality of teeth formed on the outer periphery of the detection target; and the first rotation angle detector includes a light emitter configured to emit light toward the detection target, and a light receiver configured to receive light transmitted through the detection target.

A second aspect of the present invention resides in a gear for use in a multi-rotational absolute rotation angle detecting device, including: a detection target made of a transparent resin allowing transmission of light and configured to have, formed thereon, an optical pattern for detecting the absolute rotation angle within one rotation; and a plurality of teeth formed on the outer periphery of the detection target.

According to the present invention, it is possible to reduce the thickness of a multi-rotational absolute rotation angle detecting device.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a vertical sectional view showing a schematic configuration of an encoder device according to an embodiment of the present invention;

FIG. 2 is a plan view showing a first gear, a gear train and the like included in the encoder device according to the embodiment of the present invention;

FIG. 3 is a vertical sectional view showing a schematic configuration of an encoder device of Modification 1;

FIG. 4 is a plan view showing a first gear, a gear train and the like of the encoder device of Modification 1;

FIG. 5 is a vertical sectional view showing a schematic configuration of an encoder device of Modification 2; and

FIG. 6 is a diagram showing a schematic configuration of a conventional encoder device.

### DESCRIPTION OF THE PREFERRED EMBODIMENTS

The multi-rotational absolute rotation angle detecting device and the gear according to the present invention will be detailed by describing preferred embodiments with reference to the accompanying drawings.

### Embodiment

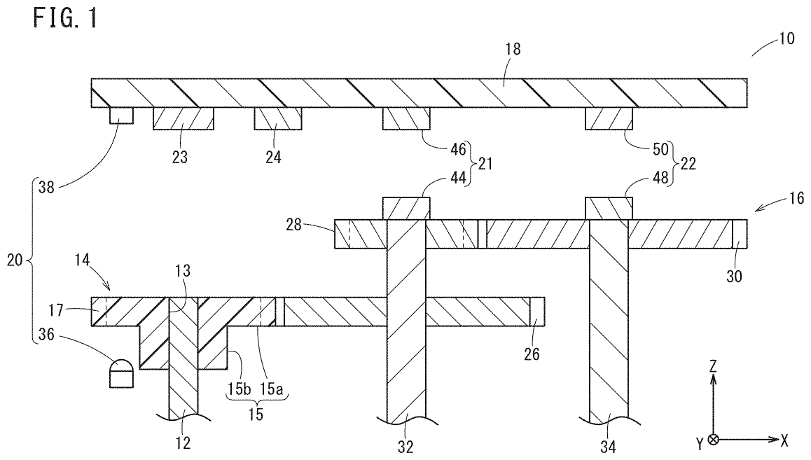

FIG. 1 is a vertical sectional view showing a schematic configuration of an encoder device 10 as an example of the multi-rotational absolute rotation angle detecting device of the present invention. The encoder device 10 is an optical multi-rotational absolute encoder (rotation angle detecting device). The following description will be given using the three-dimensional XYZ orthogonal coordinate system shown in FIG. 1 etc.

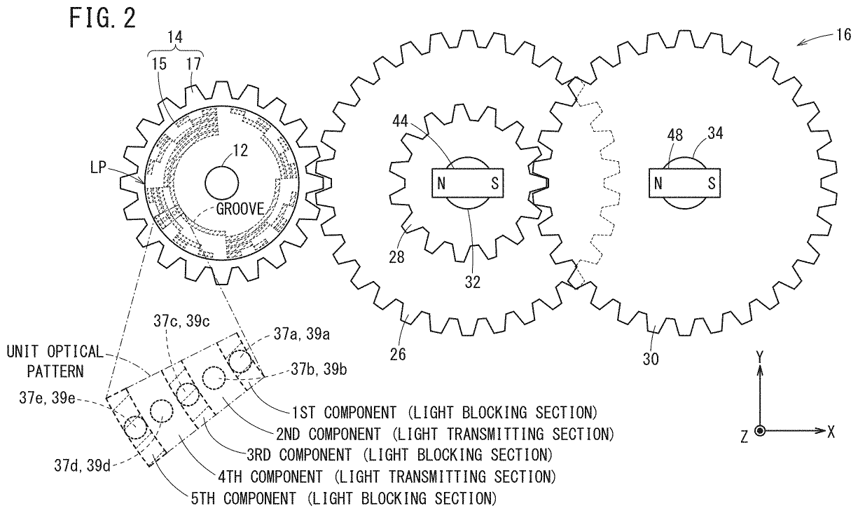

As shown in FIG. 1, the encoder device 10 includes an encoder shaft 12, a first gear 14, a gear train 16, a printed circuit board 18, a first sensor 20, a second sensor 21, a third sensor 22, and a signal processing unit 23. In FIG. 2, the first gear 14, the gear train 16 and the like are illustrated in a plan view.

The encoder shaft 12 is a shaft arranged parallel to the Z-axis as shown in FIGS. 1 and 2, and is rotatably supported by an unillustrated housing via a bearing. In the encoder device 10, the encoder shaft 12 is coupled with, for example, a rotating member of a machine tool or a robot, or a rotating shaft of a motor, so that the encoder device can detect the rotation angle (more detailedly, the number of revolutions and the angle of rotation after a full revolution) of the rotating member or the rotating shaft. Further, this encoder can detect a distance of movement of a moving object when the moving object is moved using a converting mechanism for converting the rotating motion of a rotating member or a rotary shaft into translational motion. Hereinafter, the encoder shaft 12 is also referred to as “first shaft 12”. Examples of the material of the first shaft 12 include metals, alloys and resins.

The first gear 14 is coaxially fixed to the first shaft 12. That is, the first gear 14 rotates about the rotation axis of the first shaft 12 together with the first shaft 12. The first gear 14 is made of a translucent resin (transparent resin), and has a detection target 15 and a plurality of teeth 17. The first gear 14 and the first shaft 12 may be integrally molded of a light transmitting resin.

The detection target 15 includes, for example, a large-diametric portion 15a and a small-diametric portion 15b (also referred to as a “boss portion”), and has a substantially top hat shape (axisymmetric shape) as a whole. The large-diametric portion 15a has, formed therein, an optical pattern LP for detecting the absolute rotation angle (the absolute value of the rotation angle) within one rotation range. The detection target 15 has, formed in a center thereof, a hole 13 extending in the Z-axis direction so that the first shaft 12 can be fitted thereinto. That is, the detection target 15 is coaxially fixed to the first shaft 12.

The large-diametric portion 15a has a plurality of arc-shaped grooves (for example, V-shaped in section) extending around the rotation axis of the first shaft 12 on the negative Z-side surface of the outer peripheral portion (portion projecting from the small-diametric portion 15b). These grooves are formed on concentric circles at random (the positions and lengths around the rotation axis are irregular) (see FIG. 2). Each groove is a groove (for example, one having a V-shaped section) that totally reflects incident light, that is, has a light blocking function. The outer peripheral flat portion of the large-diametric portion 15a where no groove is formed, has a light transmitting function allowing transmission of incident light.

The multiple grooves constitute the optical pattern LP. Here, a structural unit of the optical pattern, which corresponds to one unit of absolute rotation angle to be detected within one rotation, obtained by equally dividing the optical pattern LP, is referred to as a “unit optical pattern”. Each unit optical pattern transmits or reflects at least part of incident light. More specifically, as shown in a partially enlarged view of a certain unit optical pattern taken from the optical pattern LP in FIG. 2, each unit optical pattern is composed of light transmitting sections (flat portions) and light blocking sections (groove portions) arranged in the radial direction of the large-diametric portion 15a. Each unit optical pattern has a different arrangement of light transmitting sections and light blocking sections in the radial direction of the detection target 15, from others. Therefore, the pattern of transmitted light generated when the whole of each unit optical pattern is illuminated, differs from others.

As can be understood from the above description, the multiple grooves constituting the optical pattern LP are formed so that the pattern of light that has transmitted through the detection target 15 as a result of irradiating the detection target 15 with light at each absolute rotation angle to be detected in one rotation, is different from others.

The optical pattern LP can be appropriately changed as long as it has multiple unit optical patterns different from one another for each rotation angle to be detected in one rotation.

The multiple teeth 17 are provided on the outer periphery of the large-diametric portion 15a of the detection target 15 at a predetermined pitch.

The gear train 16 includes a second gear 26, a third gear 28 and a fourth gear 30. Examples of the material of the gears of the gear train 16 include metals, alloys, and resins.

The second gear 26 is a gear having a larger diameter than the first gear 14 (the number of teeth of the second gear is greater than that of the first gear), meshing with the first gear 14 and coaxially fixed to a second shaft 32 disposed parallel to the first shaft 12 (parallel to the Z-axis). That is, the second gear 26 rotates about the rotation axis of the second shaft 32 together with the second shaft 32. The second shaft 32 is rotatably supported by the housing (not shown) via a bearing and located on the +X-side of the first shaft 12 when viewed from the negative side of the Y-axis.

The third gear 28 is a gear having a smaller diameter than the second gear 26 (the number of teeth of the third gear is smaller than that of the second gear), and is coaxially fixed to the second shaft 32. That is, the third gear 28 rotates about the rotation axis of the second shaft 32 together with the second shaft 32. The third gear 28 is disposed on the distal end side of the second shaft 32 (on the +Z-side) with respect to the second gear 26.

The fourth gear 30 is a gear meshing with the third gear 28, having a larger diameter (having a greater number of teeth) than the third gear 28 and coaxially fixed to a third shaft 34 arranged parallel to the first shaft 12 and the second shaft 32 (parallel to the Z-axis). That is, the fourth gear 30 rotates about the rotation axis of the third shaft 34 together with the third shaft 34. The third shaft 34 is rotatably supported by the housing (not shown) via a bearing so as to be located on the +X-side of the second shaft 32 when viewed from the negative side of the Y-axis.

With the above configuration, when rotational torque is transmitted to the first shaft 12, the first shaft 12 and the first gear 14 rotate in one direction around the rotation axis of the first shaft 12 (about the Z-axis). As a result, the second gear 26, the third gear 28 and the second shaft 32 rotate in a direction opposite to the rotational direction of the first shaft 12 and the first gear 14 while the fourth gear 30 and the third shaft 34 rotate in the same direction as that of the first shaft 12 and the first gear 14. As the first shaft 12 and the first gear 14 rotate N times, the second gear 26, the third gear 28 and the second shaft 32 rotate once. As the second gear 26, the third gear 28 and the second shaft 32 rotate M times, the fourth gear 30 and the third shaft 34 rotate once.

The printed circuit board 18 is disposed substantially parallel with the XY plane (on the +Z-side of the gear train 16 and the first gear 14) so as to oppose the first gear 14 and the gear train 16.

The first sensor 20 includes a light emitter 36 and a light receiver 38, disposed apart from each other in the Z-axis direction so as to sandwich the outer peripheral portion of the large-diametric portion 15a of the first gear 14 (hereinafter, also simply referred to as “the outer periphery of the first gear 14”) on which the optical pattern LP is formed. That is, the outer periphery of the first gear 14 is located between the light emitter 36 and the light receiver 38. Herein, the light receiver 38 is mounted on the surface on the negative Z-side of the printed circuit board 18 while the light emitter 36 is fixed to the unillustrated housing so that light is emitted toward the light receiver 38 (in the +Z-direction).

The light emitter 36 includes a plurality of (e.g., five) light emitting elements 37 (37a, 37b, 37c, 37d, 37e) arranged orthogonal to the rotation axis of the first shaft 12 (in the radial direction of the detection target 15) so as to be face-to-face with five respective components (light transmitting and blocking sections) of the unit optical pattern (see FIG. 2), and a driver circuit 24 for driving (turning on) each of light emitting elements 37. The driver circuit 24 is provided on, for example, the printed circuit board 18. Each light emitting element 37 and the driver circuit 24 are connected by using wiring paths different from the wiring paths on the printed circuit board 18. The driver circuit 24 causes multiple light emitting elements 37 to emit light continuously during the detection operation of the encoder device 10.

The light receiver 38 includes, for example, five light receiving elements 39 (39a, 39b, 39c, 39d, 39e) arranged orthogonal to the rotation axis of the first shaft 12 (in the radial direction of the detection target 15) so as to be face-to-face with five respective components (light transmitting and blocking sections) of the unit optical pattern (see FIG. 2).

Here, for example, as shown in the partially enlarged view of FIG. 2, the five components (the light transmitting and blocking sections) in each unit optical pattern will be named in order from the component closest to the first shaft 12, as the first component, the second component, the third component, the fourth component and the fifth component. The light emitting element 37a and the light receiving element 39a are disposed apart from each other in the Z-axis direction so as to sandwich the first component. The light emitting element 37b and the light receiving element 39b are disposed apart from each other in the Z-axis direction so as to sandwich the second component. The light emitting element 37c and the light receiving element 39c are disposed apart from each other in the Z-axis direction so as to sandwich the third component. The light emitting element 37d and the light receiving element 39d are disposed apart from each other in the Z-axis direction so as to sandwich the fourth component. The light emitting element 37e and the light receiving element 39e are disposed apart from each other in the Z-axis direction so as to sandwich the fifth component. In the unit optical pattern shown in the partially enlarged view of FIG. 2, the first, third and fifth components are light blocking sections, whereas the second and fourth components are light transmitting sections.

Thus, the light emitting elements 37a to 37e correspond to the multiple light receiving elements 39a to 39e individually.

With the above configuration, the light emitted from the light emitting element 37a and incident on the light transmitting section of the unit optical pattern passes through the light transmitting section and enters the light receiving element 39a. The light emitted from the light emitting element 37a and incident on the light blocking section of the unit optical pattern is blocked (for example, totally reflected) by the light blocking section and does not enter the light receiving element 39a. The light emitted from the light emitting element 37b and incident on the light transmitting section of the unit optical pattern passes through the light transmitting section and enters the light receiving element 39b. The light emitted from the light emitting element 37b and incident on the light blocking section of the unit optical pattern is blocked (for example, totally reflected) by the light blocking section and does not enter the light receiving element 39b. The light emitted from the light emitting element 37c and incident on the light transmitting section of the unit optical pattern passes through the light transmitting section and enters the light receiving element 39c. The light emitted from the light emitting element 37c and incident on the light blocking section of the unit optical pattern is blocked (for example, totally reflected) by the light blocking section and does not enter the light receiving element 39c. The light emitted from the light emitting element 37d and incident on the light transmitting section of the unit optical pattern passes through the light transmitting section and enters the light receiving element 39d. The light emitted from the light emitting element 37d and incident on the light blocking section of the unit optical pattern is blocked by the light blocking section (for example, total reflection) and does not enter the light receiving element 39d. The light emitted from the light emitting element 37e and incident on the light transmitting section of the unit optical pattern passes through the light transmitting section and enters the light receiving element 39e. The light emitted from the light emitting element 37e and incident on the light blocking section of the unit optical pattern is blocked by the light blocking section (for example, total reflection) and does not enter the light receiving element 39e.

When the first gear 14 rotates together with the first shaft 12 in a state where the multiple light emitting elements 37a to 37e are emitting light, multiple unit optical patterns sequentially pass transversely across the optical paths of light from the multiple light emitting elements 37a to 37e. The light emitted from each light emitting element 37 and incident on the corresponding light transmitting section of each unit optical pattern is transmitted through the light transmitting section and then enters the corresponding light receiving element 39, so that a signal is output from the light receiving element 39. On the other hand, the light emitted from each light emitting element 37 and incident on the corresponding light blocking section of each unit optical pattern is blocked (for example, totally reflected) and does not enter the corresponding light receiving element 39, so that no signal is output from the light receiving element 39. That is, when light is emitted from the light emitter 36 onto the rotating optical pattern LP, light of a different pattern is emitted from the optical pattern LP for every absolute rotation angle to be detected within one rotation, and enters the light receiver 38. The output signal of each light receiving element 39 is sent to the signal processing unit 23.

As the light emitting element 37, for example, an LD (laser diode), an LED (light emitting diode) or the like is used. Further, as the light emitted from the light emitting element 37, for example, infrared light is used, but light other than infrared light (for example, visible light) may be used. In addition, the light emitter 36 may have a lens (for example, a coupling lens) for suppressing divergence of light, on the optical path from each light emitting element 37 to the outer periphery of the first gear 14.

As the light receiving element 39, for example, a PD (photodiode), a phototransistor or the like is used. Further, the light receiver 38 may have a focusing lens for focusing light on the light receiving element 39, on the optical path from the outer periphery of the first gear 14 to each light receiving element 39.

The second sensor 21 is a sensor that detects the rotation angle of the second shaft 32 and includes a magnet 44 and a Hall element 46. The magnet 44 is attached to a distal end face (an end face on the +Z-side) of the second shaft 32 so that the direction of a line connecting the N pole and the S pole is substantially orthogonal to the second shaft 32. The Hall element 46 is mounted at a position facing the magnet 44 on the surface on the −Z-side of the printed circuit board 18. As the magnet 44 rotates together with the second shaft 32, the direction of the magnetic field of the magnet 44 changes, and the phase of the signal output from the Hall element 46 changes accordingly. That is, from the output signal of the Hall element 46, the rotation angle within one rotation of the second shaft 32 can be detected. The output signal of the Hall element 46 is sent to the signal processing unit 23.

The third sensor 22 is a sensor that detects the rotation angle of the third shaft 34, and includes a magnet 48 and a Hall element 50. The magnet 48 is attached to a distal end face (a surface on the +Z-side) of the third shaft 34 so that the direction of a line connecting the N pole and the S pole is substantially orthogonal to the third shaft 34. The Hall element 50 is mounted at a position facing the magnet 48 on the surface on the −Z-side of the printed circuit board 18. As the magnet 48 rotates together with the third shaft 34, the direction of the magnetic field of the magnet 48 changes, and the phase of the signal output from the Hall element 50 changes accordingly. That is, from the output signal of the Hall element 50, the rotation angle within one rotation of the third shaft 34 can be detected. The output signal of the Hall element 50 is sent to the signal processing unit 23.

The signal processing unit 23 is mounted on the surface on the −Z-side of the printed circuit board 18. The signal processing unit 23 identifies the unit optical pattern illuminated with light, based on the output signal of each light receiving element 39 of the first sensor 20, whereby the absolute rotation angle within one rotation of the first shaft 12 (the absolute rotation angle corresponding to the unit optical pattern) is detected. Further, the signal processing unit 23 detects the number of rotations of the first shaft 12 based on the detection result of the second sensor 21 (the output signal from the Hall element 46) and the detection result of the third sensor 22 (the output signal from the Hall element 50).

That is, the signal processing unit 23 detects where the first shaft 12 is rotationally positioned, i.e., how many times the first shaft has rotated and the absolute rotation angle in one revolution.

### Modifications

The configuration of the encoder device 10 described in the above embodiment can be changed as appropriate.

### Modification 1

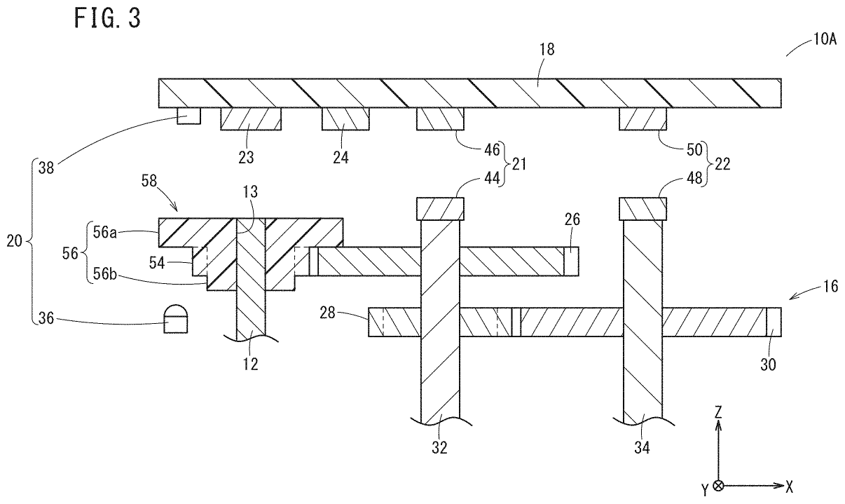

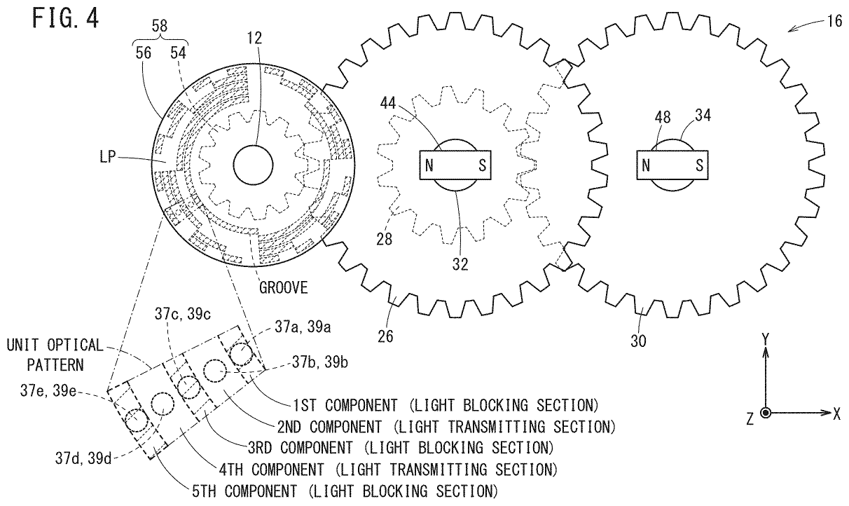

In the above embodiment, although the first gear 14 in which multiple teeth 17 are provided on the outer periphery of the large-diametric portion 15a is used, the present invention is not limited to this. For example, as in Modification 1 shown in FIGS. 3 and 4, use may be made of a first gear 58 which includes a detection target 56 having a large-diametric portion 56a and a small-diametric portion 56b and also includes a plurality of teeth 54 formed on the outer periphery of the small-diametric portion 56b. In this case, the encoder device, named 10A, can be thinned as in the above embodiment. In this case, the encoder device 10A can be made compact also with respect to the direction (X-axis direction) orthogonal to the rotation axis of the first shaft 12. More specifically, the distance between the first shaft 12 and the second shaft 32 can be shortened (the second gear 26 and the third gear 28 can be reduced in diameter), and the distance between the second shaft 32 and the third shaft 34 can be shortened (the fourth gear 30 can be reduced in diameter). In FIG. 3, the arrangement of the second gear 26, the third gear 28 and the fourth gear 30 is changed from that of FIG. 1 as a result of forming the multiple teeth 54 on the outer periphery of the small-diametric portion 56b of the detection target 56. Specifically, the positional relationship between the second gear 26 and the third gear 28 is reversed, and the fourth gear 30 is disposed at a position where it engages with the third gear 28 that has been changed in position. In this case, as the diameter of the diametric portion provided with the multiple teeth is smaller, the encoder device 10A can be smaller in the width direction (X-axis direction). That is, from the viewpoint of making the encoder device 10A compact in the width direction, it is preferable that, in the detection target, multiple teeth should be provided on one of the diametric portions that has a diameter other than the largest diameter.

### Modification 2

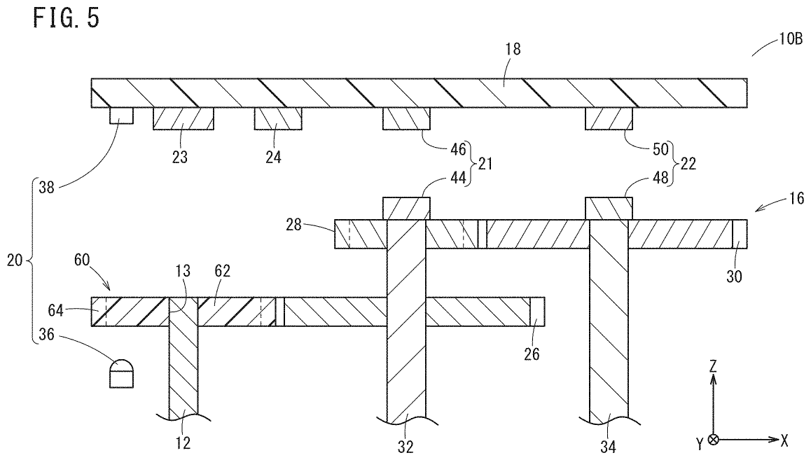

In the above embodiment, the first gear 14 is formed with two diametric portions having different diameters in a direction orthogonal to the first shaft 12. However, as in Modification 2 shown in FIG. 5, the first gear may be formed with only one diametric portion (e.g., a substantially disc shape, a substantially cylindrical shape, etc.), and alternatively may have three or more diametric portions. As shown in FIG. 5, when a first gear 60 is formed into a substantially disc shape (a disk shape without any boss) as a whole which has a substantially disc-shaped detection target 62 and multiple teeth 64, the resulting encoder device, designated at 10B, can be made further thinner.

### Modification 3

In the above embodiment and Modifications, the two-stage gear train 16 is engaged with the first gear 14, 58 or 60, but the present invention can achieve desired effect as long as a gear train of one or more stages is engaged with the first gears 14, 58 or 60. That is, a configuration may be adopted in which the fourth gear 30, the third shaft 34 and the third sensor 22 of the gear train 16 are removed from the configuration of FIG. 1, FIG. 3 or FIG. 5. Alternatively, at least one gear including a gear meshing with the fourth gear 30 of the gear train 16, a rotary shaft of the gear and a sensor for detecting the rotation angle of the rotary shaft may be added.

### Modification 4

The configurations of the second sensor 21 and the third sensor 22 may have any other configurations as long as they can detect the rotation angle of the corresponding rotary shaft.

### Modification 5

In the embodiment and Modifications described above, the light receiver 38 has a plurality of light receiving elements 39, but it may have a single light receiving element 39. In this case, by shifting or staggering the light emission timings of the multiple light emitting elements 37 in the light emitter 36, the multiple light emitting elements 37 can irradiate the unit optical pattern at different timings. Owing thereto, the signal processing unit 23 can determine the presence or absence of the signal output from the single light receiving element 39 as to the light emission of each light emitting element 37. As a result, the unit optical pattern irradiated by the light emitter 36 can be identified.

### Modification 6

The light emitter 36 may be configured to include a single light emitting element 37 with a light deflector (for example, a galvano mirror, a MEMS mirror, etc.) for deflecting the light from the light emitting element 37 in the radial direction of the detection target 15 so as to scan the unit optical pattern. In this case, since the timing of scanning each component (a light transmitting section or a light blocking section) of the unit optical pattern is different, the single light receiving element 39 covering all the components of the unit optical pattern may be used in the light receiver 38, or a plurality of light receiving elements 39 corresponding to the respective components of the unit optical pattern may be used.

### Modification 7

The light emitter 36 may be configured to have a single light emitting element 37 and a cylindrical lens that shapes the light from the light emitting element 37 into a linearly spread light beam with which the whole unit optical pattern is irradiated. In this case, since all the components (light transmitting and blocking sections) of the unit optical pattern are irradiated with light illuminates at the same time, it is necessary to provide multiple light receiving elements 39 corresponding to the respective multiple components of the unit optical pattern.

### Modification 8

The number of components (light transmitting and blocking sections) in each unit optical pattern which is a constituent unit of the optical pattern LP is not limited to the specific number (e.g., five) described in the above embodiment and Modifications. In any case, it is preferable to set the number of light emitting elements 37 and light receiving elements 39 in accordance with the number of components in the unit optical pattern.

### Modification 9

Modifications 1 to 8 may be arbitrarily combined as long as no technical consistency occurs. [The Inventions that can be Grasped from the Embodiment and Modifications 1 to 9]

### [First Invention]

The multi-rotational absolute rotation angle detecting device (10) of the first invention includes: a first shaft (12); a first gear (14) provided on the first shaft (12) and configured to rotate about the rotation axis of the first shaft (12); a second shaft (32); a second gear (26) provided on the second shaft (32) and configured to rotate about the rotation axis of the second shaft (32) and mesh with the first gear (14); a first rotation angle detector (20) configured to detect the rotation angle of the first shaft (12); and a second rotation angle detector (21) configured to detect the rotation angle of the second shaft (32). In this configuration, the first gear (14) is made of a transparent resin allowing transmission of light, and includes a detection target (15) on which an optical pattern (LP) for detecting the absolute rotation angle within one rotation is formed, and a plurality of teeth (17) formed on the outer periphery of the detection target (15), and the first rotation angle detector (20) includes a light emitter (36) configured to emit light toward the detection target (15), and a light receiver (38) configured to receive the light transmitted through the detection target (15).

Thus, the multiple teeth (17) are provided on the outer periphery of the detection target (15) on which the optical pattern (LP) is formed, so that it is possible to provide a thinner multi-rotational absolute rotation angle detecting device (10), compared to the conventional configuration in which the gear corresponding to the first gear (14) and the rotor corresponding to the detection target (15) are stacked together in the direction of the rotation axis.

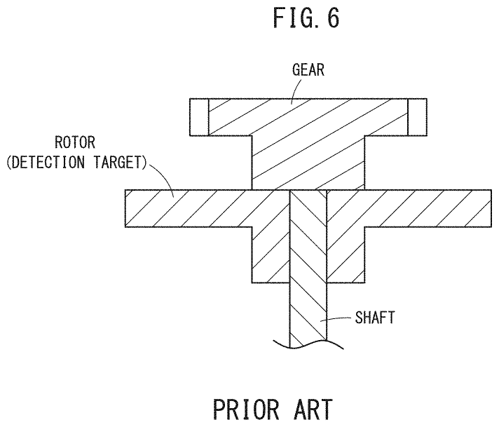

That is, in the prior art, it is necessary to secure a space in the thickness direction of the encoder device in order to install a rotor (detection target) and a gear that are stacked together in the direction of the rotation axis, and hence there has been room for improvement in thinning the multi-rotational absolute rotation angle detecting device (10) (see FIG. 6).

Furthermore, in the multi-rotational absolute rotation angle detecting device (10), it is possible to reduce the number of parts, compared to the case where the rotor corresponding to the detection target (15) and the gear corresponding to the first gear (14) are separate members (i.e., formed separately from each other).

It is preferable that the detection target (15) has a plurality of diametric portions (15a, 15b) arranged in a direction in which the rotation axis of the first shaft (12) extends, and configured to have different diameters in a direction orthogonal to the rotation axis, and the multiple teeth (17) are provided on an outer periphery of a diametric portion (15b) other than a diametric portion (15a) that has a largest diameter, among the plurality of diametric portions (15a, 15b). In this case, the distance between the first shaft (12) and the second shaft (32) can be shortened, so that the multi-rotational absolute rotation angle detecting device (10) can be downsized in the direction perpendicular to the rotation axis of the first shaft (12).

It is preferable that the multi-rotational absolute rotation angle detecting device (10) of the present invention further includes: a third gear (28) provided on the second shaft (32) and configured to rotate about the rotation axis of the second shaft (32) and have a diameter smaller than that of the second gear (26); a third shaft (34); a fourth gear (30) provided on the third shaft (34) and configured to rotate about the rotation axis of the third shaft (34) and mesh with the third gear (28); and a third rotation angle detector (22) configured to detect the rotation angle of the third shaft (34). In this case, in the multi-rotational absolute rotation angle detecting device (10), it is possible to count the larger number of revolutions of the first shaft (12) while suppressing an increase in size in the direction perpendicular to the rotation axis of the first shaft (12).

### [Second Invention]

A gear (14) of the second invention resides in a gear for use in a multi-rotational absolute rotation angle detecting device (10), which includes: a detection target (15) made of a transparent resin allowing transmission of light and configured to have, formed thereon, an optical pattern (LP) for detecting the absolute rotation angle within one rotation; and a plurality of teeth (17) formed on the outer periphery of the detection target (15).

With this configuration, a gear that integrally includes the optical pattern (LP) and the multiple teeth (17) can be realized, and consequently it is possible to provide a thinner multi-rotational absolute rotation angle detecting device (10).

In the gear (14), since the detection target (15) and the multiple teeth (17) are integrated, the number of parts can be reduced.

While the invention has been particularly shown and described with reference to the preferred embodiments, it will be understood that variations and modifications can be effected thereto by those skilled in the art without departing from the scope of the invention as defined by the appended claims.

What is claimed is:

1. A multi-rotational absolute rotation angle detecting device comprising:
a first shaft,
a first gear provided on the first shaft and configured to rotate about a rotation axis of the first shaft;
a second shaft;
a second gear provided on the second shaft and configured to rotate about a rotation axis of the second shaft and mesh with the first gear;
a first rotation angle detector configured to detect a rotation angle of the first shaft; and
a second rotation angle detector configured to detect a rotation angle of the second shaft, wherein:
the first gear is made of a transparent resin allowing transmission of light, and includes a detection target on which an optical pattern configured to detect an absolute rotation angle within one rotation is formed, and a plurality of teeth formed on an outer periphery of the detection target; and
the first rotation angle detector includes a light emitter configured to emit light toward the detection target, and a light receiver configured to receive light transmitted through the detection target.

2. The multi-rotational absolute rotation angle detecting device according to claim 1, wherein:
the detection target has a plurality of diametric portions arranged in a direction in which the rotation axis of the first shaft extends, and configured to have different diameters in a direction orthogonal to the rotation axis; and
the multiple teeth are provided on an outer periphery of a diametric portion other than a diametric portion that has a largest diameter, among the plurality of diametric portions.

3. The multi-rotational absolute rotation angle detecting device according to claim 1, further comprising:
a third gear provided on the second shaft and configured to rotate about the rotation axis of the second shaft and have a diameter smaller than that of the second gear;
a third shaft;
a fourth gear provided on the third shaft and configured to rotate about a rotation axis of the third shaft and mesh with the third gear; and
a third rotation angle detector configured to detect a rotation angle of the third shaft.

4. A gear for use in a multi-rotational absolute rotation angle detecting device, comprising:
a detection target made of a transparent resin allowing transmission of light and configured to have, formed thereon, an optical pattern configured to detect an absolute rotation angle within one rotation; and
a plurality of teeth formed on an outer periphery of the detection target.
